(19) United States
(12) Patent Application Publication
(10) Pub. No.: US 2025/0367747 A1
(43) Pub. Date: Dec. 4, 2025

(54) HYBRID WELDING-TYPE POWER SUPPLIES HAVING BIDIRECTIONAL AC-DC CONVERTERS

(71) Applicant: ILLINOIS TOOL WORKS INC., GLENVIEW, IL (US)

(72) Inventors: Benjamin J. Janquart, Milwaukee, WI (US); Charles J. Romenesko, Hortonville, WI (US)

(21) Appl. No.: 19/224,070

(22) Filed: May 30, 2025

Related U.S. Application Data
(60) Provisional application No. 63/654,515, filed on May 31, 2024.

(51) Int. Cl. B23K 9/10; B23K 9/067; B23K 9/095

(52) U.S. Cl. CPC B23K 9/1043; B23K 9/067; B23K 9/0956; B23K 9/1081

(57) ABSTRACT

Disclosed example welding-type power supplies include: an energy storage device; an AC auxiliary output to output AC output power based on AC input power; power conversion circuitry configured to convert the AC input power to DC output power; and a bidirectional AC-DC converter configured to convert the AC input power to output DC power to the energy storage device, and to convert DC power from the energy storage device to output AC power as the AC input power to the AC auxiliary output and the power conversion circuitry.

### RELATED APPLICATIONS

The present application claims the benefit of U.S. Provisional Patent Application Ser. No. 63/654,515, filed May 31, 2024, entitled “HYBRID WELDING-TYPE POWER SUPPLIES HAVING BIDIRECTIONAL AC-DC CONVERTERS.” The entirety of U.S. Provisional Patent Application Ser. No. 63/654,515 is expressly incorporated herein by reference.

### FIELD OF THE DISCLOSURE

This disclosure relates generally to welding systems and, more particularly, to hybrid welding-type power supplies having bidirectional AC-DC converters.

### BACKGROUND

Conventional engine-driven welding power supplies and/or hybrid welding power supplies include a welding module that draws power from a DC voltage bus. The DC voltage bus can supply power to different output modules to supply AC and/or DC power. However, conventional engine-driven welding power supplies and/or hybrid welding power supplies undergo multiple conversions, which can result in increased conversion losses and reduced efficiency of the system. Additionally, larger numbers of conversion stages increases the likelihood of a failure.

### SUMMARY

Hybrid welding-type power supplies having bidirectional AC-DC converters are disclosed, substantially as illustrated by and described in connection with at least one of the figures, as set forth more completely in the claims.

### BRIEF DESCRIPTION OF THE DRAWINGS

FIG. 1 is a block diagram of an example welding system including a hybrid welding-type power supply having a bidirectional AC-DC converter, in accordance with aspects of this disclosure.

FIG. 2 is a block diagram of an example hybrid welding-type system having a bidirectional AC-DC converter coupled to an AC auxiliary output, in accordance with aspects of this disclosure.

FIG. 3 is a more detailed schematic diagram of an example implementation of the hybrid welding-type system of FIG. 1.

FIGS. 4A and 4B represent a flowchart representative of example machine readable instructions which may be executed by the control circuitry of FIGS. 1 and/or 2 to control the example hybrid welding-type system of FIGS. 1 and/or 2.

The figures are not necessarily to scale. Wherever appropriate, similar or identical reference numerals are used to refer to similar or identical components.

### DETAILED DESCRIPTION

Disclosed example hybrid welding-type systems reduce the number of power conversion stages between different input sources and output modules. In disclosed examples, an AC bus couples different input sources, such as an AC input or battery input, and output modules, such as welding or other DC outputs, AC output, and/or battery charging. Some disclosed example hybrid welding-type systems reduce the number of power conversion stages for combinations of inputs and outputs. In some such examples, the hybrid welding-type systems do not increase power conversion stages for any of the input-output combinations in the welding-type system.

Disclosed example hybrid welding-type systems reduce the number of conversion stages: from an AC input to an AC output from two conversions to zero conversions; from an AC input to a welding-type output from two conversions to one conversion; from an AC input to a battery-charging input from two conversion to one conversion; from a battery input (e.g., the same battery) to the AC output from two conversions to one conversion; and from the battery input to the welding-type output remains at two conversions.

Disclosed example welding-type power supplies include: an energy storage device; an AC auxiliary output to output AC output power based on AC input power; power conversion circuitry configured to convert the AC input power to DC output power; and a bidirectional AC-DC converter configured to convert the AC input power to output DC power to the energy storage device, and to convert DC power from the energy storage device to output AC power as the AC input power to the AC auxiliary output and the power conversion circuitry.

Some example welding-type power supplies further include an engine-driven generator configured to output AC power as the AC input power to the AC auxiliary output, the power conversion circuitry, and the bidirectional AC-DC converter. In some examples, the bidirectional AC-DC converter is configured to convert the DC power from the energy storage device to AC power to supplement the AC input power from the engine-driven generator.

Some example welding-type power supplies further include a switching device configured to control charging or discharging of the energy storage device, in which the bidirectional AC-DC converter configured to convert the AC input power to output DC power to the energy storage device when the switching device is controlled to charge the energy storage device. In some example welding-type power supplies, the switching device includes: a switching element configured to enable or disable charging of the energy storage device by the bidirectional AC-DC converter; and a diode configured to allow discharging of the energy storage device while the switching element is open. In some example welding-type power supplies, the switching device includes: a switching element configured to enable or disable charging of the energy storage device by the bidirectional AC-DC converter, and configured to enable or disable discharging of the energy storage device.

Some example welding-type power supplies further include control circuitry configured to, in response to initiating a welding-type process, control the bidirectional AC-DC converter to convert DC power from the energy storage device to the AC input power, and control the power conversion circuitry to convert the AC input power from the bidirectional AC-DC converter to output welding-type power. Some example welding-type power supplies further include a current sensor configured to measure a current of at least one of the AC input power or the welding-type power, the control circuitry configured to control the bidirectional AC-DC converter to convert the DC power from the energy storage device to the AC input power in response to the measured current exceeding a threshold current.

In some example welding-type power supplies, the control circuitry is configured to control the bidirectional AC-DC converter and the power conversion circuitry to supply all of the welding-type power from the energy storage device. Some example welding-type power supplies further include a voltage sensor configured to measure a voltage of at least one of the AC input power or the welding-type power; and a current sensor configured to measure a current of the at least one of the AC input power or the welding-type power, the control circuitry configured to determine a measured power of the at least one of the AC input power or the welding-type power, and control the bidirectional AC-DC converter to convert the DC power from the energy storage device to the AC input power in response to the measured power exceeding a threshold power.

Some example welding-type power supplies further include a current sensor configured to measure a current of at least one of the DC power from the energy storage device or the welding-type power, the control circuitry configured to control an engine-driven generator to output AC input power in response to the measured current exceeding a threshold current. In some example welding-type power supplies, the power conversion circuitry is configured to output the DC output power as welding-type power. In some example welding-type power supplies, the AC input power is three-phase AC power.

Disclosed example welding-type systems include: an engine-driven generator configured to generate AC input power; an AC auxiliary output to output AC output power based on the AC input power; power conversion circuitry configured to convert the AC input power to DC output power; an energy storage device; a bidirectional AC-DC converter configured to convert the AC output power to output DC power to the energy storage device, and configured to convert DC power from the energy storage device to output AC power to the power conversion circuitry via the AC auxiliary output, the bidirectional AC-DC converter being detachably connected to the AC auxiliary output.

Some example welding-type systems further include a switching device configured to control charging or discharging of the energy storage device. In some example welding-type systems, the switching device includes: a switching element configured to enable or disable charging of the energy storage device by the bidirectional AC-DC converter; and a diode configured to allow discharging of the energy storage device while the switching element is open. In some example welding-type systems, the switching device includes: a switching element configured to enable or disable charging of the energy storage device by the bidirectional AC-DC converter, and configured to enable or disable discharging of the energy storage device.

Some example welding-type systems further include control circuitry configured to, in response to initiating a welding-type process, control the bidirectional AC-DC converter to convert DC power from the energy storage device to the AC input power, and control the power conversion circuitry to convert the AC input power from the bidirectional AC-DC converter to output welding-type power. Some example welding-type systems further include a current sensor configured to measure a current of at least one of the AC input power or the welding-type power, the control circuitry configured to control the bidirectional AC-DC converter to convert the DC power from the energy storage device to the AC input power in response to the measured current exceeding a threshold current. In some example welding-type systems, the control circuitry is configured to control the bidirectional AC-DC converter and the power conversion circuitry to supply all of the welding-type power from the energy storage device.

As used herein, the term “welding-type power” refers to power suitable for welding, plasma cutting, induction heating, CAC-A and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “recognized battery unit” refers to a battery unit that is approved, authorized, and/or otherwise has identifiable minimum characteristics, such as charge state, nominal voltage, minimum voltage, maximum voltage, and/or charge capacity. Recognition can occur through signaling, measurement, and/or any other mechanism.

As used herein, a “circuit” includes any analog and/or digital components, power and/or control elements, such as a microprocessor, digital signal processor (DSP), software, and the like, discrete and/or integrated components, or portions and/or combinations thereof.

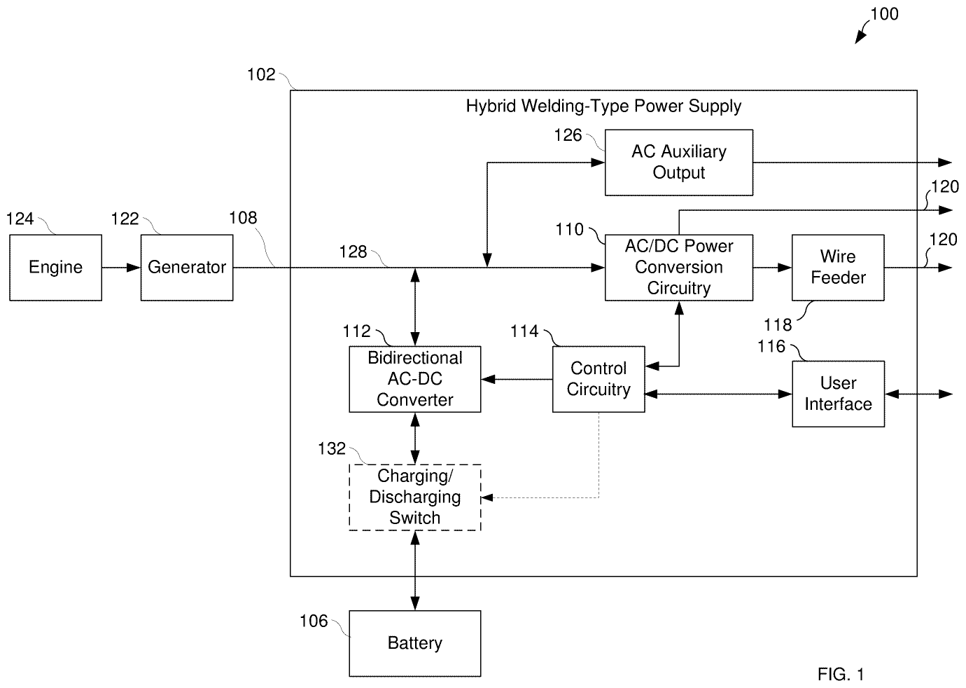

FIG. 1 is a block diagram of an example welding system 100 including a hybrid welding-type power supply 102. The example hybrid welding-type power supply 102 is connected to one or more batteries 106. The battery 106 may include any type or combination of types of energy storage devices, such as batteries, supercapacitors, thermal energy storage, chemical energy storage, and/or mechanical energy storage devices. The battery 106 (or other energy storage device) may be an external battery, a removable internal battery, or an integrated internal battery. While the following examples are discussed with reference to batteries, this disclosure applies to any other type of energy storage that is capable of adaptation for welding.

The hybrid welding-type power supply 102 may also be connected to an external source of AC input power 108 from a power source such as a generator 122 driven by an engine 124, a battery-powered inverter supply, and/or any other AC power source. The example engine 124 is a diesel, gasoline, or other fuel-driven engine. The generator 122 converts mechanical power from the engine 124 to the AC input power 108, which may be single-phase or three-phase power. The hybrid welding-type power supply 102 may be powered by either or both of the battery 106 or the AC input power 108 at any given time.

When the hybrid welding-type power supply 102 is connected to both the engine-driven generator 122 and to the battery 106, the hybrid welding-type power supply 102 may charge the battery 106. Conversely, when energy is required that is not available from the engine-driven generator 122, the battery 106 may provide power to the hybrid welding-type power supply 102. In some other examples, the battery 106 is charged separately from the power supply 102 (e.g., via an external charger), and provides power to the power supply 102.

The example hybrid welding-type power supply 102 includes AC-to-DC (AC-DC) power conversion circuitry 110, a bidirectional AC-DC converter 112, control circuitry 114, a user interface 116, a wire feeder 118, and an AC auxiliary output 126. In the example of FIG. 1, the AC input power 108, the AC-DC power conversion circuitry, the bidirectional AC-DC converter 112, and the AC auxiliary output 126 are coupled to a same AC bus 128.

The AC-DC power conversion circuitry 110 is a circuit that converts AC current power to DC output power, such as welding-type power 120, battery charging power (e.g., 12 VDC, 24 VDC), and/or any other DC output.

The power conversion circuitry 110 converts the energy present at the AC bus 128 to the welding-type output 120. For example, the power conversion circuitry 110 may include an AC-DC buck converter, a forward converter, a flyback converter, and/or any other desired topology. The control circuitry 114 controls the power conversion circuitry 110 to perform the conversion based on specified weld parameters and feedback.

The bidirectional AC-DC converter 112 is a circuit that converts AC power (e.g., from the AC input power 108 via the AC bus 128) to DC power charge the battery 106. The bidirectional AC-DC converter 112 also converts the stored power in the battery 106 to converted power to output to the power conversion circuitry 110 (e.g., via the AC bus 128) for output to the power conversion circuitry 110 and/or the AC auxiliary output 126. In other examples, the bidirectional AC-DC converter 112 is replaced with separate converters (e.g., a AC-DC buck converter and an inverter) to charge the battery 106 and to discharge the battery 106.

The example power supply 102 may further include a charging/discharging switch 132 coupling the bidirectional AC-DC converter 112 to the battery 106. The charging/discharging switch 132 may control charging and/or discharging of the battery 106 by the bidirectional AC-DC converter 112. In some examples, the charging/discharging switch 132 controls one of charging or discharging, the other of charging or discharging is permitted to occur on demand. For example, the charging/discharging switch 132 may include a switching device to control charging, and a diode to permit discharging when the switching device is controlled to be open.

The AC auxiliary output 126 outputs AC power from the AC bus 128 to one or more connected devices. For example, the AC auxiliary output 126 may be a pass through output connector or receptacle that outputs the AC power from the AC input power 108 and/or the bidirectional AC-DC converter 112 to a device that is connected to (e.g., plugged into) the AC auxiliary output 126.

The control circuitry 114 may include a processor or other logic circuitry. The control circuitry 114 may include any general purpose central processing unit (CPU), embedded processing system, or system-on-chip from any manufacturer. In some other examples, the control circuitry 114 may include one or more specialized processing units, such as graphic processing units and/or digital signal processors. The control circuitry 114 executes machine readable instructions that may be stored locally at the processor (e.g., in an included cache), in a random access memory (or other volatile memory), in a read only memory (or other non-volatile memory such as FLASH memory), and/or in a mass storage device. Example mass storage devices may be a hard drive, a solid state storage drive, a hybrid drive, a RAID array, and/or any other mass data storage device.

The control circuitry 114 controls the power conversion circuitry 110 to output the welding-type output 120. The control circuitry 114 controls the bidirectional AC-DC converter 112 to convert power from the AC bus 128 to charge the battery 106 and/or controls the bidirectional AC-DC converter 112 to convert power from the battery 106 to provide the converted battery power to the power conversion circuitry 110. In some examples, the control circuitry 114 further controls the charging/discharging switch 132 to enable and/or disable the charging and/or discharging of the battery 106.

The power from the battery 106 may supplement the AC input power 108 on the AC bus 128, and/or the AC input power 108 may supplement the AC power provided to the AC bus 128 from the battery 106. The control circuitry 114 further controls the bidirectional AC-DC converter 112 to charge the battery 106 when the AC input power 108 is available and at least a portion of the AC input power 108 is available for charging the battery 106 (e.g., the AC input power 108 is not completely consumed by the power conversion circuitry 110 and/or the wire feeder 118). Conversely, the control circuitry 114 controls the bidirectional AC-DC converter 112 to convert power from the battery 106 to provide the converted battery power to the power conversion circuitry 110 when a demand for welding power is higher than can be provided by the AC input power 108, and/or when the AC input power 108 is unavailable.

The example wire feeder 118 includes a wire feed motor to provide electrode wire to the welding operation (e.g., when the welding operation involves a wire feeder, such as when gas metal arc welding, flux cored arc welding, etc.). When the welding operation involves a wire feeder, the control circuitry 114 controls powers the wire feeder 118. The wire feeder 118 may be powered by the welding-type output 120 or by another output from the power conversion circuitry 110. In some other examples, the wire feeder 118 may be a separate device connected to the welding-type output 120 external to the hybrid welding-type power supply 102.

The user interface 116 enables input to the hybrid welding-type power supply 102 and/or output from the hybrid welding-type power supply 102 to a user. The control circuitry 114 may indicate the state of charge of the battery 106 and/or a mode of operation, such as a battery charging mode, an external power welding mode (e.g., welding mode powered by the AC input power 108), a combination welding-charging mode (e.g., welding and charging the battery 106 using AC input power 108), a battery powered welding mode, or a hybrid welding mode (e.g., welding boost mode powered by utility power and battery power), of the hybrid welding-type power supply 102 via the user interface 116.

The user interface 116 further includes inputs to allow an operator to specify welding parameters, such as a workpiece thickness, output voltage, output current, wire feed speed, welding wire diameter, welding wire type, welding process, pulse frequency, pulse magnitude, and/or any other desired welding parameter values.

In some examples, the user interface 116 may provide a utility power selection input that defines different levels of power to be drawn from the AC input power 108 (e.g., with the balance drawn from the battery 106). Example AC power levels may include a low AC input draw level (e.g., limit utility drawn to only levels necessary to sustain the welding), a medium AC input draw level, and a high AC input draw level (e.g., limit power drawn from the battery 106).

The example user interface 116 may include one or more I/O devices, such as a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device.

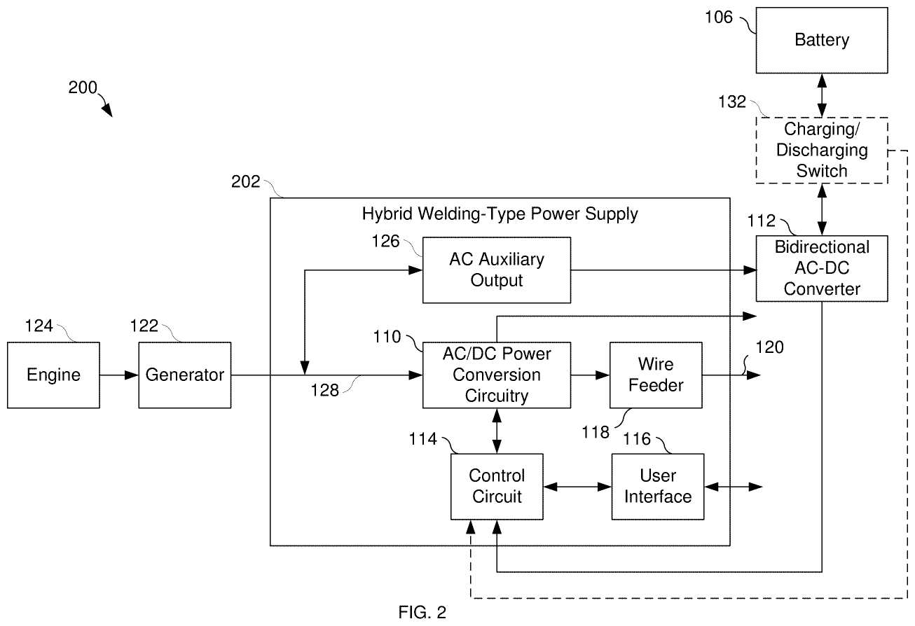

FIG. 2 is a block diagram of an example hybrid welding-type system 200 having a hybrid welding-type power supply 202 including a bidirectional AC-DC converter coupled to an AC auxiliary output. The example hybrid welding-type power supply 202 includes the AC input power 108, the AC-DC power conversion circuitry 110, the control circuitry 114, the user interface 116, the wire feeder 118, the AC auxiliary output 126, and the AC bus 128 described above with reference to FIG. 1.

In the example of FIG. 2, a supplemental battery module 204 is connected to the power supply 202 via the AC auxiliary output 126. The supplemental battery module 204 includes the bidirectional AC-DC converter 112, and may include the charging/discharging switch 132. In such examples, the AC auxiliary output 126 is a pass through connection between the AC bus 128 and the supplemental battery module 204, such that the bidirectional AC-DC converter 112 is coupled to the AC bus 128. In some examples, the supplemental battery module 204 is connected to the battery 106, and may be plugged into and/or otherwise detachably connected to a receptacle of the AC auxiliary output 126 (e.g., in a same manner as an AC-powered tool would be plugged into the AC auxiliary output 126 to be supplied with power), wired into the AC auxiliary output 126. In this manner, the supplemental battery module 204 may be retrofitted to an AC-powered welding-type power supply or engine-driven welding-type power supply to operate as a hybrid welding-type system.

The supplemental battery module 204 is further coupled to the control circuitry 114 to enable control of the bidirectional AC-DC converter 112 and/or the charging/discharging switch 132. For example, the supplemental battery module 204 may be coupled to a communications and/or control connection, such as a 14-pin connector used on some types of welding-type power supplies. However, other connections may be used, such as a USB-type connector, an Ethernet connector, and/or any other type of standard or specialized connection.

In the illustrated examples, the example engine 124 and generator 122 are separate components from the power supply 102. For example, the AC input power 108 may be provided to the power supply 102 may be connected to the generator 122 via a plug or wiring the power supply 102 to the generator 122. In other examples, the engine 124 and/or the generator 122 are incorporated into the hybrid welding-type power supply 102 as an engine-driven hybrid welding-type power supply.

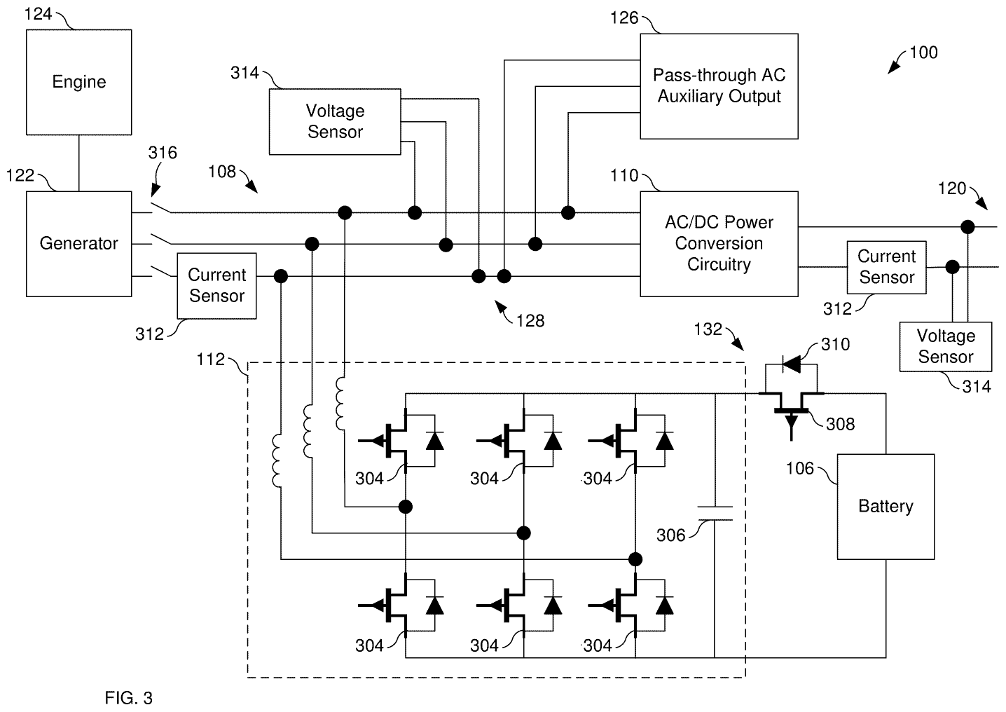

FIG. 3 is a more detailed schematic diagram of an example implementation of the hybrid welding-type system 100 of FIG. 1. The example implementation of FIG. 3 may be modified to implement the example hybrid welding-type system 200 of FIG. 2. In the example of FIG. 3, the generator 122 generates and outputs three-phase AC power as the AC input power 108 to the AC bus 128, which is a three-phase AC bus.

The example bidirectional AC-DC converter 112 of FIG. 3 includes a three-phase bidirectional switching rectifier 302, which includes switching elements 304 coupled to each of the phases. The switching elements 304 rectify the three-phase AC power from the AC bus 128 to DC power, which is smoothed by a capacitor 306 and output to the battery 106. In the example of FIG. 3, the charging/discharging switch 132 couples the DC output of the bidirectional AC-DC converter 112 to the battery 106 to control charging and/or discharging. The example charging/discharging switch 132 of FIG. 3 includes a switching element 308 and a diode 310. The switching element 308 is controlled by the control circuitry 114 to enable or disable charging of the battery 106. The diode 310 allows discharge of the battery 106 by the bidirectional AC-DC converter 112 when the switching element 308 is controlled to be open.

Other topologies and/or types of switching elements 304, 308 may be used. For example, the bidirectional AC-DC converter 112 may be configured with switching elements 304 that allow for control, enabling, and disabling of both charging and discharging to be performed with the bidirectional AC-DC converter 112. In such examples, the charging/discharging switch 132 may be omitted. In other examples, the diode 310 may be omitted from the charging/discharging switch 132, and the switching element 308 is controlled to enable and disable both charging and discharging of the battery 106.

The example system 100 of FIG. 3 further includes one or more current sensors 312 and/or one or more voltage sensors 314. The current sensor(s) 312 measure a current of the AC input power 108 and/or the welding-type output 120, and/or the voltage sensor(s) 314 measure a voltage of the AC input power 108 and/or the welding-type output 120. The measured current(s), measured voltage(s), and/or measured power may indicate whether more power is being drawn by the AC auxiliary output 126 and/or by the AC-DC power conversion circuitry 110 than can be supported by the AC input power 108 or the battery 106. For example, the control circuitry 114 may have threshold current(s), threshold voltage(s), and/or threshold power(s) representative of the upper limits of power delivery by the AC input power 108 and/or the battery 106. In some examples, the control circuitry 114 controls the bidirectional AC-DC converter 112 to convert the DC power from the battery 106 to the AC bus 128 in response to the measured current exceeding a threshold current, the threshold voltage, or the threshold power (e.g., to supplement the AC input power 108 with power from the battery 106). In other examples, the control circuitry 114 controls the engine 124 and/or the generator 122 to provide or increase the AC input power 108 to the AC bus 128 in response to the measured current exceeding a threshold current, the threshold voltage, or the threshold power (e.g., to supplement the power from the battery 106 with power from the engine-driven generator 122).

In the example of FIG. 3, the generator 112 is coupled to the AC bus 128 via switches 316. Example switches 316 include contactors, high power MOSFETs, and/or any other type of switching devices. The switches 316 may be controlled to open (e.g., disconnect the generator 112) while the engine 124 is off and the bidirectional AC-DC converter 112 is being controlled to convert power from the battery 106 to the AC bus 128. By disconnecting the generator 112, the generator 112 is prevented from consuming power as an electric motor.

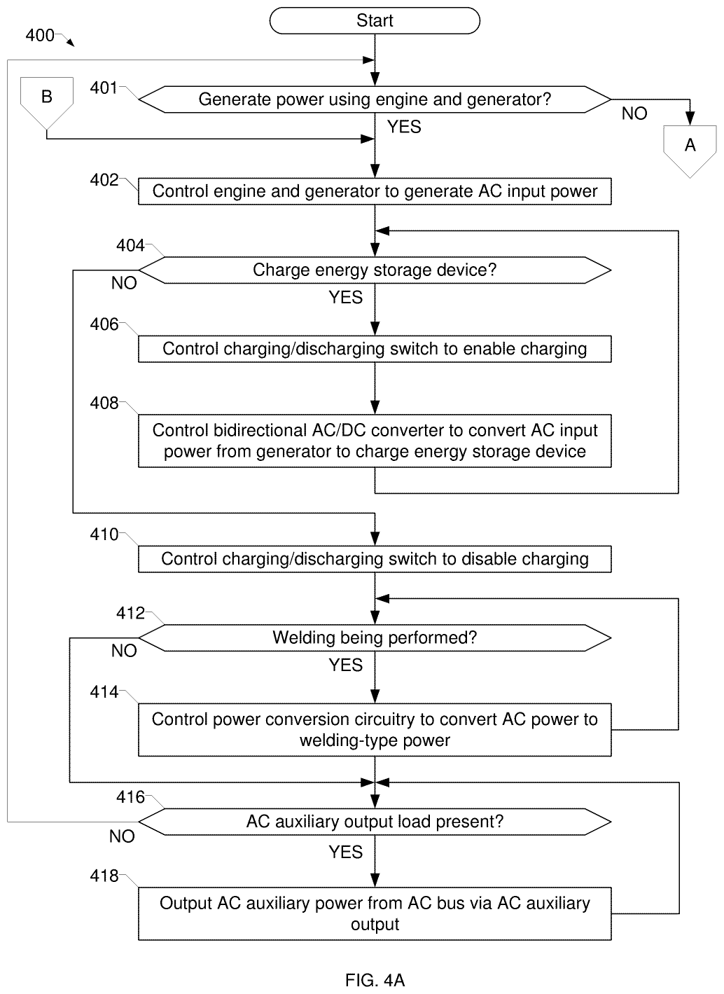

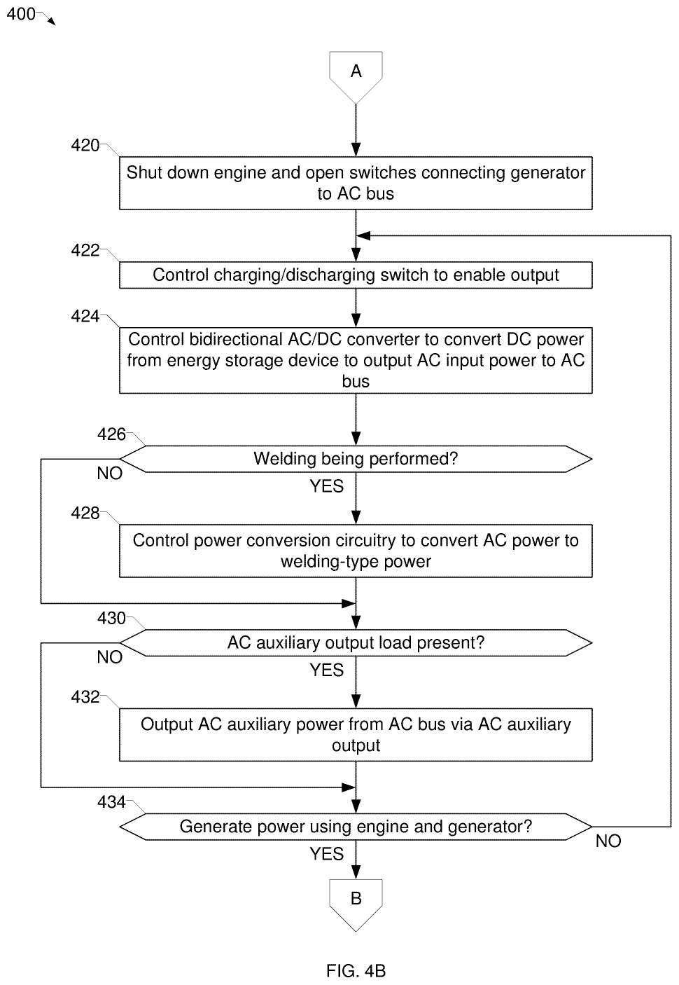

FIGS. 4A and 4B represent a flowchart representative of example machine readable instructions 400 which may be executed by the control circuitry 114 of FIGS. 1 and/or 2 to control the example hybrid welding-type systems 100, 200 of FIGS. 1 and/or 2.

At block 401, the control circuitry 114 determines whether to generate power using the engine 124 and the generator 122. For example, the control circuitry 114 may determine whether the engine 124 has been idle for a predetermined period of time, whether the battery 106 has less than a threshold charge, and/or whether at least a threshold load is applied to the generator 122. If the engine 124 and the generator 122 are to be used to generate power (block 401), at block 402, the control circuitry 114 controls the engine 124 and the generator 122 to generate AC input power 108. The generator 122 outputs the AC input power 108 to the AC bus 128.

At block 404, the control circuitry 114 determines whether a connected energy storage device (e.g., the battery 106) is to be charged. For example, the control circuitry 114 may determine whether there is AC input power 108 available to charge the battery 106 that is not being consumed by the AC auxiliary output 126 or the AC-DC power conversion circuitry 110 (e.g., a welding-type output). If the battery 106 is to be charged (block 404), at block 406 the control circuitry 114 controls the charging/discharging switch 132 to enable charging. At block 408, the control circuitry 114 controls the bidirectional AC-DC converter 112 to convert the AC input power 108 from the generator 122 to charge the battery 106. For example, the control circuitry 114 may control the switching elements 304 of FIG. 3 to rectify the AC input power 108 from the AC bus 128 to DC power to charge the battery 106. Control then returns to block 404.

If the battery 106 is not to be charged (block 404), at block 410 the control circuitry controls the charging/discharging switch 132 to disable charging. For example, the control circuitry 114 may control the switching element 308 to turn off or open.

At block 412, the control circuitry 114 determines whether welding is being performed. For example, the control circuitry 114 may monitor for a trigger signal and/or determine whether measured voltage and/or current (e.g., via sensors 312, 314) at the output of the AC-DC power conversion circuitry 110 indicates that welding power is being output. Other types of DC power may be output, such as plasma cutting or other welding-type power, and/or battery charging power. If welding is being performed (block 412), at block 414 the control circuitry 114 controls the power conversion circuitry 110 to convert AC power (e.g., from the generator 122 and/or from the bidirectional AC-DC converter 112 to welding-type power. The control circuitry 114 may further control the bidirectional AC-DC converter 112 to convert DC power from the battery 106 to AC power for supplying the AC-DC power conversion circuitry 110. Control then returns to block 412.

If welding is not being performed (block 412), at block 416 the control circuitry 114 determines whether an AC auxiliary output load is present. For example, the control circuitry 114 may monitor for whether measured voltage and/or current (e.g., via sensors 312, 314) at the AC input power 108 indicates that the AC auxiliary output 126 is drawing a load. If an AC auxiliary load is present (block 416), at block 418 the AC auxiliary output 126 outputs AC auxiliary power from the AC bus 128 (e.g., the AC input power 108 and/or the bidirectional AC-DC converter 112). If an AC auxiliary load is not present (block 416), control returns to block 401 to determine whether to continue using the engine 124 and the generator 122 to generate power.

Turning to FIG. 4B, if the engine 124 and the generator 122 are not to be used to generate power (block 401), at block 420 the control circuitry 114 controls the engine 124 to shut down, and opens the switches 316 coupling the generator 122 to the AC bus 128.

At block 422, the control circuitry 114 controls the charging/discharging switch 132 to enable output from the battery 106 (e.g., by closing or turning on the charging/discharging switch 132). At block 424, the control circuitry 114 controls the bidirectional AC/DC converter 112 to convert DC power from the battery 106 to output AC input power to the AC bus 128. For example, the control circuitry 114 may control the switches 304 to generate three-phase AC power to the three phase AC bus 128 by controlling the on/off switching of the switches 304.

At block 426, the control circuitry 114 determines whether welding is being performed. Block 426 may be similar or identical to block 412 described above. If welding is being performed (block 426), at block 428 the control circuitry 114 controls the power conversion circuitry 110 to convert AC power (e.g., from the generator 122 and/or from the bidirectional AC-DC converter 112 to welding-type power.

If welding is not being performed (block 426), or in addition to the welding being performed (block 428), at block 430 the control circuitry 114 determines whether an AC auxiliary output load is present. Block 430 may be similar or identical to block 416 described above. If an AC auxiliary load is present (block 430), at block 432 the AC auxiliary output 126 outputs AC auxiliary power from the AC bus 128 (e.g., the AC input power 108 and/or the bidirectional AC-DC converter 112).

If an AC auxiliary load is not present (block 430), or while outputting the AC auxiliary power (block 432), at block 434 the control circuitry 114 determines whether the engine 124 and the generator 122 should be used to generate power. Block 434 may be similar or identical to block 401, and may be performed periodically or in response to triggers to turn on the engine 124 to generate power, such as when the charge on the battery 106 decreases below a threshold level.

If the engine 124 and the generator 122 are not to be used to generate power (block 434), control returns to block 422. If the engine 124 and the generator 122 are to be used to generate power (block 434), control returns to block 402 of FIG. 4A to start the engine 124 and control the engine 124 and the generator 122 to begin generating power.

The present methods and systems may be realized in hardware, software, and/or a combination of hardware and software. Example implementations include an application specific integrated circuit and/or a programmable control circuit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A welding-type power supply, comprising:
an energy storage device;
an AC auxiliary output to output AC output power based on AC input power;
power conversion circuitry configured to convert the AC input power to DC output power; and
a bidirectional AC-DC converter configured to convert the AC input power to output DC power to the energy storage device, and to convert DC power from the energy storage device to output AC power as the AC input power to the AC auxiliary output and the power conversion circuitry.

2. The welding-type power supply as defined in claim 1, further comprising an engine-driven generator configured to output AC power as the AC input power to the AC auxiliary output, the power conversion circuitry, and the bidirectional AC-DC converter.

3. The welding-type power supply as defined in claim 2, wherein the bidirectional AC-DC converter is configured to convert the DC power from the energy storage device to AC power to supplement the AC input power from the engine-driven generator.

4. The welding-type power supply as defined in claim 1, further comprising a switching device configured to control charging or discharging of the energy storage device, wherein the bidirectional AC-DC converter configured to convert the AC input power to output DC power to the energy storage device when the switching device is controlled to charge the energy storage device.

5. The welding-type power supply as defined in claim 4, wherein the switching device comprises:
a switching element configured to enable or disable charging of the energy storage device by the bidirectional AC-DC converter; and
a diode configured to allow discharging of the energy storage device while the switching element is open.

6. The welding-type power supply as defined in claim 4, wherein the switching device comprises:
a switching element configured to enable or disable charging of the energy storage device by the bidirectional AC-DC converter, and configured to enable or disable discharging of the energy storage device.

7. The welding-type power supply as defined in claim 1, further comprising control circuitry configured to, in response to initiating a welding-type process, control the bidirectional AC-DC converter to convert DC power from the energy storage device to the AC input power, and control the power conversion circuitry to convert the AC input power from the bidirectional AC-DC converter to output welding-type power.

8. The welding-type power supply as defined in claim 7, further comprising a current sensor configured to measure a current of at least one of the AC input power or the welding-type power, the control circuitry configured to control the bidirectional AC-DC converter to convert the DC power from the energy storage device to the AC input power in response to the measured current exceeding a threshold current.

9. The welding-type power supply as defined in claim 7, wherein the control circuitry is configured to control the bidirectional AC-DC converter and the power conversion circuitry to supply all of the welding-type power from the energy storage device.

10. The welding-type power supply as defined in claim 7, further comprising:
a voltage sensor configured to measure a voltage of at least one of the AC input power or the welding-type power; and
a current sensor configured to measure a current of the at least one of the AC input power or the welding-type power, the control circuitry configured to determine a measured power of the at least one of the AC input power or the welding-type power, and control the bidirectional AC-DC converter to convert the DC power from the energy storage device to the AC input power in response to the measured power exceeding a threshold power.

11. The welding-type power supply as defined in claim 7, further comprising a current sensor configured to measure a current of at least one of the DC power from the energy storage device or the welding-type power, the control circuitry configured to control an engine-driven generator to output AC input power in response to the measured current exceeding a threshold current.

12. The welding-type power supply as defined in claim 1, wherein the power conversion circuitry is configured to output the DC output power as welding-type power.

13. The welding-type power supply as defined in claim 1, wherein the AC input power is three-phase AC power.

14. A welding-type system, comprising:
an engine-driven generator configured to generate AC input power;
an AC auxiliary output to output AC output power based on the AC input power;
power conversion circuitry configured to convert the AC input power to DC output power;
an energy storage device;
a bidirectional AC-DC converter configured to convert the AC output power to output DC power to the energy storage device, and configured to convert DC power from the energy storage device to output AC power to the power conversion circuitry via the AC auxiliary output, the bidirectional AC-DC converter being detachably connected to the AC auxiliary output.

15. The welding-type system as defined in claim 14, further comprising a switching device configured to control charging or discharging of the energy storage device.

16. The welding-type system as defined in claim 15, wherein the switching device comprises:
a switching element configured to enable or disable charging of the energy storage device by the bidirectional AC-DC converter; and
a diode configured to allow discharging of the energy storage device while the switching element is open.

17. The welding-type system as defined in claim 15, wherein the switching device comprises:
a switching element configured to enable or disable charging of the energy storage device by the bidirectional AC-DC converter, and configured to enable or disable discharging of the energy storage device.

18. The welding-type system as defined in claim 14, further comprising control circuitry configured to, in response to initiating a welding-type process, control the bidirectional AC-DC converter to convert DC power from the energy storage device to the AC input power, and control the power conversion circuitry to convert the AC input power from the bidirectional AC-DC converter to output welding-type power.

19. The welding-type system as defined in claim 14, further comprising a current sensor configured to measure a current of at least one of the AC input power or the welding-type power, the control circuitry configured to control the bidirectional AC-DC converter to convert the DC power from the energy storage device to the AC input power in response to the measured current exceeding a threshold current.

20. The welding-type system as defined in claim 14, wherein the control circuitry is configured to control the bidirectional AC-DC converter and the power conversion circuitry to supply all of the welding-type power from the energy storage device.
